(19) United States
(12) Patent Application Publication
(10) Pub. No.: US 2013/0224446 A1
(43) Pub. Date: Aug. 29, 2013

(54) BIODEGRADABLE PACKAGE WITH SEALANT LAYER

(71) Applicants: Todd FAYNE, Dallas, TX (US); Kenneth Scott LAVERDURE, Plano, TX (US); Brad Dewayne RODGERS, Frisco, TX (US); Steven Kenneth TUCKER, Hurst, TX (US)

(72) Inventors: Todd FAYNE, Dallas, TX (US); Kenneth Scott LAVERDURE, Plano, TX (US); Brad Dewayne RODGERS, Frisco, TX (US); Steven Kenneth TUCKER, Hurst, TX (US)

(73) Assignee: FRITO-LAY NORTH AMERICA, INC., Plano, TX (US)

(21) Appl. No.: 13/406,371

(22) Filed: Feb. 27, 2012

(51) Int. Cl. C09J 7/02; B32B 15/04; B32B 3/10; B32B 7/12; B32B 37/02; B32B 37/24

(52) U.S. Cl. 428/195.1; 156/280; 156/244.11; 428/209; 428/354; 428/344; 428/349

(57) ABSTRACT

A multi-layer packaging film comprising a bio-based layer and method for making the same. An outer layer comprising a bio-based film is adhered to a product side layer comprising a bio-based film having barrier properties. A non-compostable sealant layer is pattern applied to a portion of the product side layer. Because a portion of the bio-based product side layer is exposed, upon opening of the package the product side layer is susceptible to moisture. This allows for subsequent biodegradation or compostability of the films. In another embodiment the sealant layer comprises a water permeable material. Upon opening of the package moisture can subsequently contact the product side layer and initiate biodegradation.

### BACKGROUND OF THE INVENTION

1. Technical Field

The present invention relates to a biodegradable, bio-based flexible packaging material that can be used in packaging food products and to a method of making the bio-based packaging material.

2. Description of Related Art

Petroleum-based prior art flexible films comprise a relatively small part of the waste produced when compared to other types of packaging. Thus, it is uneconomical to recycle because of the energy required to collect, separate, and clean the used flexible film packages. Further, because the petroleum films are environmentally stable, petroleum based films have a relatively low rate of degradation. Consequently, discarded packages that become inadvertently dislocated from intended waste streams can appear as unsightly litter for a relatively long period of time. Further, such films can survive for long periods of time in a landfill. Another disadvantage of petroleum-based films is that they are made from oil, which many consider to be a limited, non-renewable resource. Further, the price of petroleum-based films is volatile since it is tied to the price of oil. Consequently, a need exists for a biodegradable flexible film made from a renewable resource. In one embodiment, such film should be food safe and have the requisite barrier properties to store a low moisture shelf-stable food for an extended period of time without the product staling. The film should have the requisite sealable and coefficient of friction properties that enable it to be used on existing vertical form, fill, and seal machines.

### SUMMARY OF THE INVENTION

In one embodiment, the invention comprises a multi-layer packaging film comprising: an outer layer comprising a first bio-based film; a product side layer comprising a second bio-based film with barrier properties; an adhesive layer adjacent to said outer layer and between said outer layer and said product side layer; and a sealant layer located on a side of said product side layer opposite said adhesive layer, wherein said sealant layer covers less than 50% of said product side layer, wherein said sealant layer comprises non-compostable material, and wherein said multi-layer packaging film is a flexible film. In another embodiment, the first or said second bio-based film comprises polyhydroxy-alkanoate or polylactic acid. In a preferred embodiment, the product side layer comprises a barrier layer, an adhesion layer, and a bio-based layer.

In another embodiment, the first bio-based film further comprises a graphic image. The inventive film may be biodegradable.

In one embodiment, the sealant layer is water impermeable. In another embodiment, the sealant layer comprises a first melting temperature, and wherein the second bio-based film comprises a second melting temperature, and wherein the first melting temperature is lower than the second melting temperature. In a preferred embodiment, the second bio-based film is metallized.

In another embodiment, the product side layer comprises a sealing surface, and wherein sealant layer is located on the sealing surface. In a preferred embodiment, the sealant layer is located only on said sealing surface. The sealant layer may also comprise an aqueous coating or a solvent coating.

In one embodiment, the sealant layer comprises gaps. In another embodiment, the sealant layer is activated by heat.

Another embodiment of the present invention is a multi-layer packaging film comprising: an outer layer comprising a first bio-based film; a product side layer comprising a second bio-based film with barrier properties; an adhesive layer adjacent to said outer layer and between said outer layer and said product side layer; and a sealant layer located on a side of said product side layer opposite said adhesive layer, wherein said sealant is water permeable, and wherein said multi-layer packaging film is a flexible film.

In one embodiment, the first or second bio-based film comprises polyhydroxy-alkanoate. In another embodiment, the sealant layer comprises EVOH or PVOH, or at least one of EVOH, PVOH, EVA, PVA, polysulfone, polyether sulfone, cellulose, cellulose acetate, cellulose acetate butylrate, or cellulose triacetate.

The sealant layer may also comprise an aqueous coating or a solvent coating. In one embodiment, the sealant layer is non-compostable.

In another embodiment, the invention comprises method for making a multi-layer packaging film comprising the steps of: adhering an outer layer comprising a bio-based film to a product side layer, wherein said product side layer comprises barrier properties, and wherein said product side layer comprises a bio-based layer; pattern applying a sealant layer to said product side layer, wherein said sealant layer comprises non-compostable material. In yet another embodiment, the sealant layer is water impermeable.

In a preferred embodiment, the pattern applying comprises applying only along a sealing surface of the product side layer. The pattern applying step may comprise applying via coating. In another embodiment, the adhering step occurs via extrusion, and the pattern applying occurs after the adhering step.

In another embodiment, the invention comprises a method for making a multi-layer packaging film comprising the steps of: adhering an outer layer comprising a bio-based film to a product side layer, wherein said product side layer comprises barrier properties, and wherein said product side layer comprises a bio-based layer; applying a sealant layer to said product side layer, wherein said sealant layer comprises a water permeable material. In one embodiment, the applying step comprises applying via coating. In another embodiment the adhering step occurs via extrusion, and the pattern applying occurs after the adhering step.

In a preferred embodiment, the sealant layer comprises EVOH or PVOH, or at least one of EVOH, PVOH, EVA, PVA, polysulfone, polyether sulfone, cellulose, cellulose acetate, cellulose acetate butylrate, or cellulose triacetate.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 depicts a cross-section of an exemplary prior art packaging film;

FIG. 2 depicts the exemplary formation of a prior art packaging film;

FIG. 3 depicts a vertical form, fill, and seal machine that is known in the prior art;

FIG. 4 depicts a magnified schematic cross-section of a multi-layer packaging film made according to one embodiment of the invention;

FIG. 5 is a top profile view of a film in one embodiment viewing the film from the inside of the bag; and

FIG. 6 depicts a magnified schematic cross-section of a multi-layer packaging film comprising a water permeable sealant layer made according to one embodiment of the invention.

### DETAILED DESCRIPTION

Several embodiments of Applicants' invention will now be described with reference to the drawings. Unless otherwise noted, like elements will be identified by identical numbers throughout all figures.

The present invention is directed towards use of a bio-based film as at least one of the film layers in a multi-layer flexible packaging film. As used herein, the term “bio-based film” means a polymer film made from a non-petroleum or biorenewable feedstock.

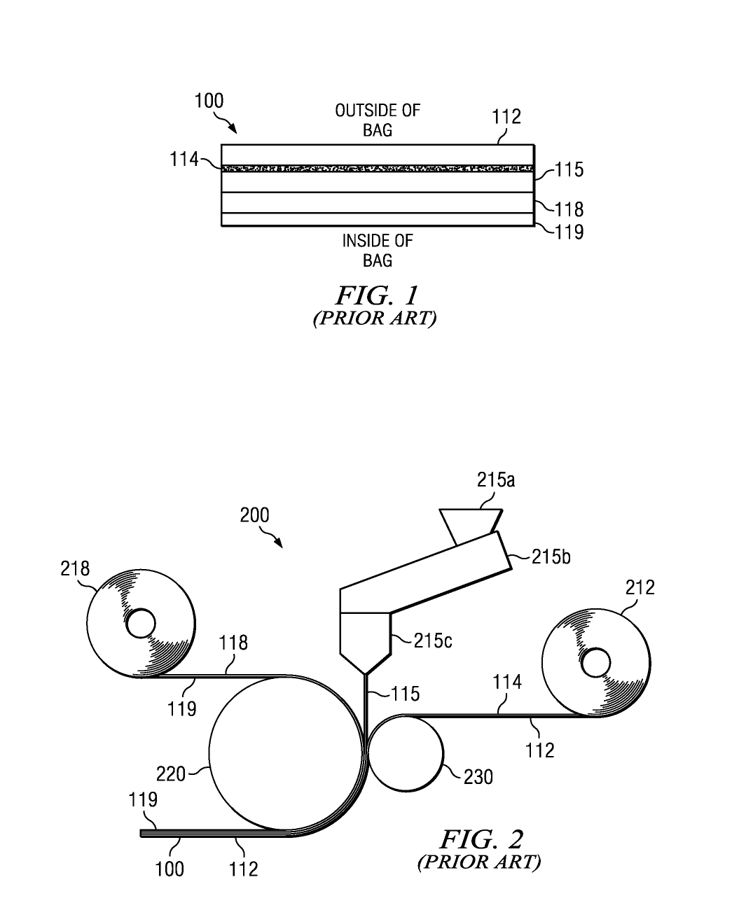

One prior art multi-layer or composite film used for packaging potato chips and like products is illustrated in FIG. 1 which is a schematic of a cross section of the multi-layer film 100 illustrating each individual substantive layer. Each of these layers functions in some way to provide the need barrier, sealant, and graphics capability properties. For example, the graphics layer 114 is typically used for the presentation of graphics that can be reverse-printed and viewed through a transparent outer base layer 112. Like numerals are used throughout this description to describe similar or identical parts, unless otherwise indicated. The outer base layer 112 is typically oriented polypropylene (“OPP”) or polyethylene terephthalate (“PET”). A metal layer disposed upon an inner base layer 118 provides the required barrier properties. It has been found and is well-known in the prior art that by metallizing a petroleum-based polyolefin such as OPP or a petroleum based polyester such as PET reduces the moisture and oxygen transmission through the film by approximately three orders of magnitude. Petroleum-based OPP is typically utilized for the base layers 112 118 because of its lower cost. A sealant layer 119 disposed upon the OPP layer 118 enables a hermetic seal to be formed at a temperature lower than the melt temperature of the OPP. A lower melting point sealant layer 119 is desirable because melting the metallized OPP to form a seal could have an adverse effect on the barrier properties. Typical prior art sealant layers 119 include an ethylene-propylene co-polymer and an ethylene-propylene-1-butene-terpolymer. A glue or laminate layer 115, typically a polyethylene extrusion, is required to adhere the outer base layer 112 with the inner, product-side base layer 118. Thus, at least two base layers of petroleum-based polypropylene are typically required in a composite or multi-layered film.

Other materials used in packaging are typically petroleum-based materials such as polyester, polyolefin extrusions, adhesive laminates, and other such materials, or a layered combination of the above.

FIG. 2 demonstrates schematically the formation of material, in which the OPP layers 112, 118 of the packaging material are separately manufactured, then formed into the final material 100 on an extrusion laminator 200. The OPP layer 112 having graphics 114 previously applied by a known graphics application method such as flexographic or rotogravure is fed from roll 212 while OPP layer 118 is fed from roll 218. At the same time, resin for PE laminate layer 115 is fed into hopper 215a and through extruder 215b, where it will be heated to approximately 600° F. and extruded at die 215c as molten polyethylene 115. This molten polyethylene 115 is extruded at a rate that is congruent with the rate at which the petroleum-based OPP materials 112, 118 are fed, becoming sandwiched between these two materials. The layered material 100 then runs between chill drum 220 and nip roller 230, ensuring that it forms an even layer as it is cooled. The pressure between the laminator rollers is generally set in the range of 0.5 to 5 pounds per linear inch across the width of the material. The large chill drum 220 is made of stainless steel and is cooled to about 50-60° F., so that while the material is cooled quickly, no condensation is allowed to form. The smaller nip roller 230 is generally formed of rubber or another resilient material. Note that the layered material 100 remains in contact with the chill drum 220 for a period of time after it has passed through the rollers, to allow time for the resin to cool sufficiently. The material can then be wound into rolls (not specifically shown) for transport to the location where it will be used in packaging. Generally, it is economical to form the material as wide sheets that are then slit using thin slitter knives into the desired width as the material is rolled for shipping.

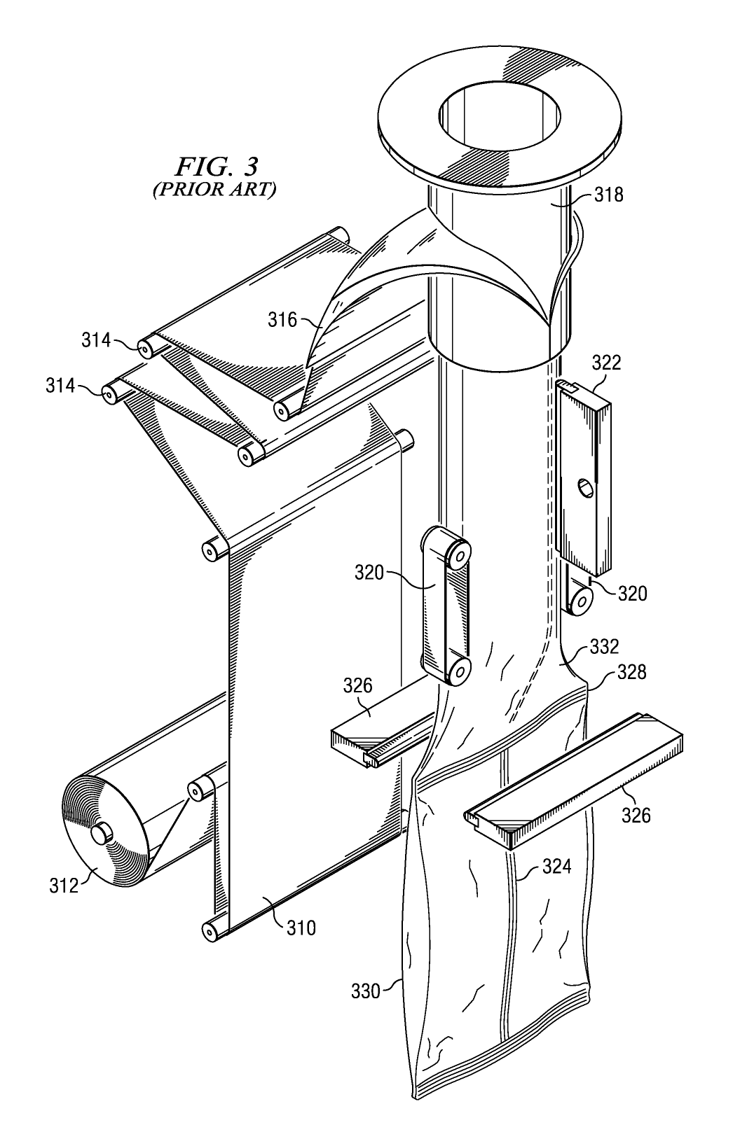

Once the material is formed and cut into desired widths, it can be loaded into a vertical form, fill, and seal machine to be used in packaging the many products that are packaged using this method. FIG. 3 shows an exemplary vertical form, fill, and seal machine that can be used to package snack foods, such as chips. This drawing is simplified, and does not show the cabinet and support structures that typically surround such a machine, but it demonstrates the working of the machine well. Packaging film 310 is taken from a roll 312 of film and passed through tensioners 314 that keep it taut. The film then passes over a former 316, which directs the film as it forms a vertical tube around a product delivery cylinder 318. This product delivery cylinder 318 normally has either a round or a somewhat oval cross-section. As the tube of packaging material is pulled downward by drive belts 320, the edges of the film are sealed along its length by a vertical sealer 322, forming a back seal 324. The machine then applies a pair of heat-sealing jaws 326 against the tube to form a transverse seal 328. This transverse seal 328 acts as the top seal on the bag 330 below the sealing jaws 326 and the bottom seal on the bag 332 being filled and formed above the jaws 326. After the transverse seal 328 has been formed, a cut is made across the sealed area to separate the finished bag 330 below the seal 328 from the partially completed bag 332 above the seal. The film tube is then pushed downward to draw out another package length. Before the sealing jaws form each transverse seal, the product to be packaged is dropped through the product delivery cylinder 318 and is held within the tube above the transverse seal 328.

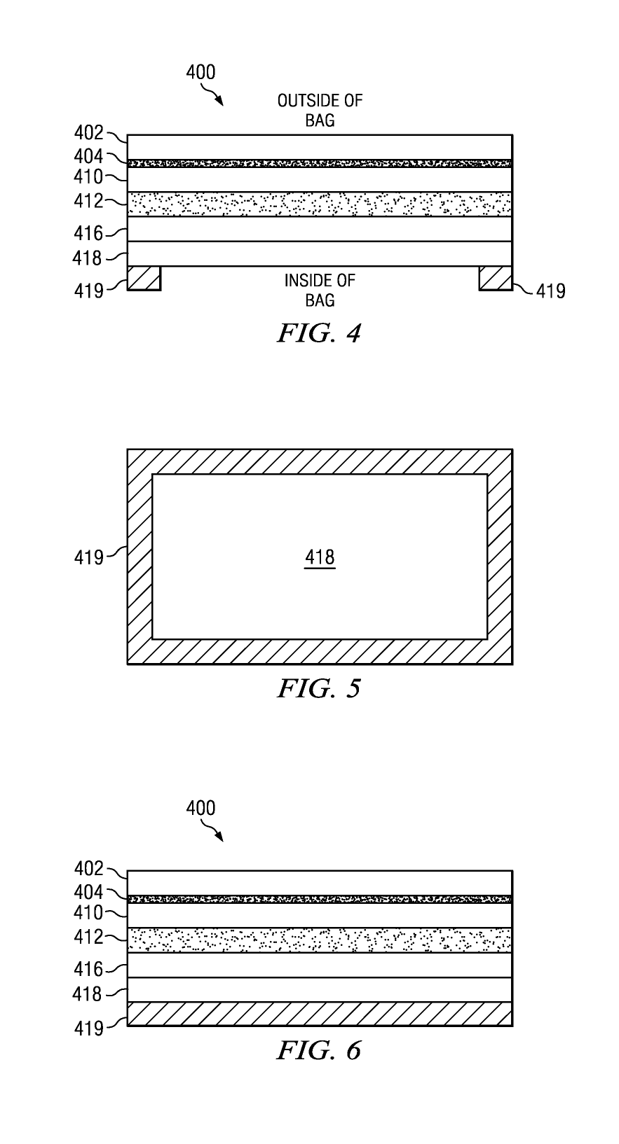

FIG. 4 depicts a magnified schematic cross-section of a multi-layer packaging film 400 made according to one embodiment of the invention. Referring to FIG. 4, the multi-layer packaging film 400 comprises a barrier layer 412 adhered by an adhesion layer 416 to an inner bio-based layer 418. These three layers can be used as a film composite for making a multilayer packaging film 400 that has both acceptable barrier properties and a bio-based film. The barrier layer 412 and any layer to the product side of the barrier layer 412 is referred to collectively as the product side layer. The inner bio-based layer is the layer of packaging film that will be layer that is closest to the inside of the final product package.

As used herein, a barrier layer 412 comprises a metal, metal oxide, metalloid oxide, and combinations thereof. Barrier layers 412 described herein can be applied to the adhesion layer 416 by any suitable method known in the art, including, but not limited to evaporation, sputtering, chemical vapor deposition, combustion chemical vapor deposition, physical vapor deposition, plasma deposition, plasma enhanced chemical vapor deposition, vacuum deposition, flame deposition, and flame hydrolysis deposition. As used herein, a multilayer packaging film 400 that has acceptable barrier properties has both acceptable oxygen barrier properties and moisture barrier properties. As used herein, a multi-layer packaging film 400 having acceptable oxygen barrier properties has an oxygen transmission rate of less than about 10 cc/m²/day (ASTM D-3985). As used herein, a multi-layer packaging film 400 having acceptable moisture barrier properties comprises a water vapor transmission rate (“WVTR”) of less than about 0.5 grams/m²/day (ASTM F-1249).

As used herein, the term “bio-based film” means a polymer film where at least 80% of the polymer film by weight is derived from a non-petroleum feedstock. In one embodiment, up to about 20% of the bio-based film can comprise a conventional polymer sourced from petroleum. Examples of bio-based films include polylactide also known as polylactic acid (“PLA”) and polyhydroxy-alkanoate (“PHA”).

PLA can be made from plant-based feedstocks including soybeans, as illustrated by U.S. Patent Application Publication Number 2004/0229327 or from the fermentation of agricultural by-products such as corn starch or other plant-based feedstocks such as corn, wheat, or sugar beets. PLA can be processed like most thermoplastic polymers into a film. PLA has physical properties similar to PET and has excellent clarity. PLA films are described in U.S. Pat. No. 6,207,792 and PLA resins are available from Natureworks LLC (http://www.natureworkllc.com) of Minnetonka, Minn. PLA degrades into carbon dioxide and biomass. PLA films used in accordance with the present invention are substantially insoluble in water under ambient conditions.

PHA is available from Telles, a joint venture of Archer Daniels Midland of Decatur, Ill. and Metabolix of Cambridge, Mass. PHA is a polymer belonging to the polyesters class and can be produced by microorganisms (e.g. Alcaligenes eutrophus) as a form of energy storage. In one embodiment, microbial biosynthesis of PHA starts with the condensation of two molecules of acetyl-CoA to give acetoacetyl-CoA which is subsequently reduced to hydroxybutyryl-CoA. Hydroxybutyryl-CoA is then used as a monomer to polymerize PHB, the most common type of PHA.

In one embodiment, any polymer or polymer blend that processes similar to the bio-based film on an orientation line, that has a relatively smooth surface (such as provided by an amorphous PET v. a crystalline PET, described in more detail below) and that has polar chemical groups, can be used as a suitable adhesion layer 416. Polar chemical groups are desirable in the adhesion layer 416 because they are attracted to the metal or metalloid barrier layer 412, and it is believed that polar chemical groups such as hydroxyl groups covalently bond to form a metal oxide or metalloid oxide upon metalization. Consequently, alcohol blends using an ethylene vinyl alcohol (“EVOH”) formula and polyvinyl alcohol (“PVOH”) are desirable, as are polymers having polar amide groups such as nylon. Further, amorphous PET and polyglycolic acid (“PGA”) having polar carbonyl groups can also be used. Consequently, in one embodiment, an adhesion layer 416 comprises one or more polar films selected from amorphous PET, PGA, various nylons including amorphous nylon, EVOH, nylon/EVOH blends, PVOH, PVOH/ethylene acrylic acid (hereinafter “EAA”) blends, and a primer.

In one embodiment, an adhesion layer 416 comprises an amorphous or glassy PET. As used herein, the terms amorphous PET and glassy PET are synonymous and defined as a PET having Tg of about 80° C. In one embodiment, amorphous PET is PET that is less than about 75% crystalline in nature. The determination of crystallinity is well known in the art and can be performed with differential scanning calorimetry (DSC) in accordance with ASTM D3418 (melting points) or ASTM E1356 (Tg). Because amorphous PET has a much smoother outer bonding surface than crystalline PET, and because the oxygen bearing groups are randomly distributed at the surface, amorphous PET provides a much better bonding surface than crystalline PET for metals such as aluminum. Further, crystalline PET has a much higher melting point and does not process in an efficient manner with PLA on an orientation line.

In one embodiment, the adhesion layer 416 is co-extruded with an inner bio-based layer 418. In one embodiment, an adhesion layer 416 comprising PET can be coextruded with the inner bio-based layer 418 and a barrier layer 412 can be applied to the adhesion layer 416 by methods known in the art.

In one embodiment, the adhesion layer 416 comprises an EVOH formula that can range from a low hydrolysis EVOH to a high hydrolysis EVOH. Below depicts EVOH formulas in accordance with various embodiments of the present invention.

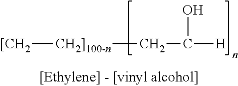

As used herein a low hydrolysis EVOH corresponds to the above formula wherein n=25. As used herein, a high hydrolysis EVOH corresponds to the above formula wherein n=80. High hydrolysis EVOH provides oxygen barrier properties but is more difficult to process. The adhesion layer 416 comprising the EVOH formula can be coextruded with the inner bio-based layer 418 and the barrier layer 412 can be applied by methods known in the art and listed above. In one embodiment, the adhesion layer 416 comprising EVOH is coated via a gravure or other suitable method onto the inner bio-based layer 418 and the barrier layer 412 can be applied onto the adhesion layer 416.

In one embodiment, the adhesion layer 416 comprises both nylon and EVOH. In such embodiment, a nylon layer is co-extruded with an inner bio-based layer 418 such as PLA and then an EVOH coating is applied onto the nylon layer, via gravure or other suitable method.

In one embodiment, the adhesion layer 416 comprises a PVOH coating that is applied to the inner bio-based layer 418 as a liquid and then dried. A barrier layer 412 can then be applied to the adhesion layer 416 comprising the dried PVOH coating.

In one embodiment, the adhesion layer 416 is applied as a solution comprising EAA and PVOH that is coated onto the inner bio-based layer 418 as a liquid and then dried. In one embodiment, a PVOH and EAA solution coating can be applied to the PLA after the PLA has been stretched or axially oriented in the machine direction. Consequently, PLA can be extruded and allowed to cool after extrusion prior to being stretched in the machine direction. A coating comprising PVOH and EAA can then be applied. For example, the solution can comprise 0.1-20% PVOH and EAA and 80-99.9% water. In one embodiment, roughly equal amounts of PVOH and EAA are used. In one embodiment, the solution comprises about 90% water, about 5% PVOH, and about 5% EAA. After the coating has been applied, the film can then be heated and subsequently stretched in the transverse direction. Such process provides an even coating for a barrier layer 412.

In one embodiment, an inner bio-based layer 418 is coated, by any suitable method including use of a mayer rod or gravure, with an adhesion layer 416 comprising a primer. As used herein, a primer is defined as any suitable coating that has polar chemical groups and also functions as a surface modifier that provides a smooth surface for a barrier layer 412. Examples of suitable primers that can be used in accordance with various embodiments of the present invention include, but are not limited to, an epoxy, maleic anhydride, ethylenemethacrylate (“EMA”), and ethylenevinylacetate (“EVA”).

In one embodiment, the adhesion layer 416 is coated with a barrier layer 412. Any suitable barrier layer 412 including, but not limited to, a metal oxide such as aluminum oxide, or a metalloid oxide such as silicon dioxide can be used. In one embodiment, another layer (not shown) comprising doped metal oxide or metalloid oxide is placed is placed onto the barrier layer 412 to provide additional barrier properties.

Additives can also be used to facilitate the application of the barrier layer 412 such as a metal to the adhesion layer 416 or to facilitate application of the adhesion layer 416 to a bio-based layer 418. As used herein, the term “additives” is not limited to chemical additives and can include surface treatment including, but not limited to, corona treatment. In one embodiment, use of the adhesion layer 416 makes it possible to provide a barrier layer 412 with no additives.

The film composite comprising a barrier layer 412 and adhesion layer 416 and a bio-based layer 418 described above, the product side layer, can then be adhered to a bio-based outer layer 402 with a bio-based or other suitable adhesive 410. In one embodiment the adhesive layer 410 is adjacent to the outer layer 402. In one embodiment the outer layer 402 comprises a bio-based film.

An outer bio-based outer layer 402 can be made by extruding a bio-based polymer into a film sheet. In one embodiment, the bio-based outer layer 402 has been oriented in the machine direction or the transverse direction. In one embodiment, the bio-based outer layer 402 comprises a biaxially oriented film. In one embodiment, PLA outer layer 402 used comprises a thickness of between about 70 gauge and about 120 gauge. In one embodiment, a graphic image 404 is reverse printed onto the bio-based outer layer 402 by a known graphics application method such as flexographic or rotogravure to form a graphics layer 404. In an alternative embodiment (not shown), a graphic image is printed onto the outside facing portion of the outer layer 402. In one embodiment, the bio-based outer layer 402 comprises multiple layers to enhance printing and coefficient of friction properties. In one embodiment, the bio-based outer layer 402 comprises one or more layers consisting essentially of PLA.

In one embodiment, after a barrier layer 412 has been applied to the adhesion layer 416, the bio-based print web 402 can be adhered to the barrier layer 412 with any suitable adhesive 410 such as LDPE. In one embodiment, a bio-based adhesive 410 is used. As used herein, the term “bio-based adhesive” means a polymer adhesive where at least about 80% of the polymer layer by weight is derived from a non-petroleum feedstock. The adhesive layer 410 can comprise any suitable bio-based adhesive such as a modified form of PLA biopolymer. In one embodiment, a starch based glue can be used as a suitable adhesive 410.

FIG. 4 also illustrates a sealant layer 419 on the side of the film that will face the interior of the package. As discussed, the sealant layer 419 enables a hermetic seal to be formed at a temperature lower than the melt temperature of the inner bio-based layer 418. Accordingly, in one embodiment the sealant layer 419 comprises a melting temperature which is lower than the melting temperature of the inner bio-based layer 418. In another embodiment the sealant layer 419 comprises a melting temperature which is lower than the melting temperature of the product side layer.

Typically, sealant layers are impermeable to water. Accordingly, if the inner bio-based layer 418 is sandwiched between an adhesion layer 416 and a water impermeable sealant layer 419, it becomes difficult for moisture to reach the bio-based layer 418. As discussed above, a skin layer is often applied to the bio-based film for enhanced metallization. These skins are not compostable and form a moisture barrier when metallized. Because moisture is necessary in the biodegradation of the bio-based layer 418, if the bio-based layer 418 is trapped between two water impermeable layers, the ability of the bio-based layer 418 to degrade is decreased or eliminated. Accordingly, when bio-based films are utilized in packaging films, if they are sandwiched between water impermeable layers, the packages do not undergo biodegradation. As used herein “moisture” refers to water in any form including liquid water and water vapor. As used herein, the term “biodegradable” means that less than about 5% by weight and preferably less than about 1% of the film remains after being left at 35° C. at 75% humidity in the open air for 60 days. Those skilled in the art will understand that at different ambient conditions, it may take longer for the film to degrade. In one embodiment, less than 5% of the bio-based film remains after being left at 25° C. and 50% relative humidity for five years. By comparison, an OPP film can last more than 100 years under these same conditions. The terms compostable and biodegradable are used interchangeably herein.

As depicted in FIG. 4, the sealant layer 419 does not cover the entire surface area of the bio-based layer 418. Instead, the sealant layer 419 is pattern applied only where a seal will be formed.

FIG. 5 is a top profile view of a film in one embodiment viewing the film from the side of the film that will become the inside of the bag. As depicted therein, the exposed inner bio-based layer 418 is visible due to the absence of the sealant layer 419 over much of its surface area. The sealant layer 419 is located along the perimeter of the film. The portion of the film which will subsequently be sealed is referred to as the sealing surface. As depicted, the two vertical edges will mate to form the back seal. The top edge will be sealed along itself to form a top end seal and the bottom edge will be sealed along itself to form a bottom end seal.

The sealant layer 419 can be applied at any location that a seal will be necessary. This results in several unexpected advantages. First, less sealant layer 419 material is necessary to form a package because the sealant layer 419 is placed strategically where it is needed to form a seal, as opposed to being applied over the entire film. This decreases the material cost of manufacturing the package. Further, because less material is required to manufacture the package, this method also results in less waste.

A second advantage is increased rate and extent of biodegradation that can occur in a package made from the film. Referring back to FIG. 4, it can be seen that once the seal formed by the sealant layer 419 is compromised, the bio-based layer 418 can be exposed to moisture which provides for subsequent biodegradation. This is contrary to what was known or taught in the art. Previously, it was desirable to prevent the passage of moisture through any layer of the film. In the present invention, however, it is desirable to ensure that the inner bio-based layer 418 be exposed to moisture after the package is opened to allow for subsequent biodegradation.

In one embodiment the sealant layer 419 covers less than about 50% of the available surface area of the bio-based layer 418. In another embodiment the sealant layer 419 covers less than about 25%, whereas in another embodiment the sealant layer 419 covers less than about 15% of the available surface area. Stated differently, in one embodiment greater than about 85% of the surface area of the bio-based film 418 is exposed.

In another embodiment, the sealant layer 419 is pattern applied to provide gaps in the sealant layer 419 which allow moisture to pass. A gap is a channel through which moisture can navigate from the inside of the product package to the bio-based layer. The moisture can then reach the inner bio-based layer 418 through the gaps and biodegradation or composting can begin. As an example, the sealant layer 419 can be applied using a calendaring roll which will form the gaps. In one such embodiment, the sealant layer 419 is applied to the entire exposed surface of the bio-based layer 418, and then portions of the sealant are removed to form the gaps. In another embodiment, the sealant layer 419 is applied to the sealing surfaces as previously discussed and the sealant layer 419 comprises gaps.

The sealant layer 419 can comprise virtually any adhesive material. In one embodiment the sealant layer 419 comprises an adhesive coating which is activated by heat including glues and polymers. In one embodiment the sealant layer 419 comprises a material which can be applied as a solution. As will be explained in more detail below, in some embodiments the sealant layer is incapable of being co-extruded with the bio-based layer 418. Accordingly, in some embodiments the sealant layer 419 is applied via an aqueous or solvent coating. In one embodiment, the sealant is an acrylic-based sealant, applied with a gravure cylinder. The sealant layer 419 can also comprise a 4032D or 4042D layer available from NatureWorks LLC of Blair, Nebr. The sealant layer can also comprise low density polyethylene. In one embodiment the sealant layer 419 comprises a non-compostable material.

In one embodiment the sealant layer 419 is water impermeable. In embodiments wherein the sealant layer 419 is water impermeable, the exposed portions of the bio-based layer 418, those which are not covered by a sealant layer 419, are susceptible to moisture, and thus biodegradation or composting, after the package is opened. The non-exposed portions of the bio-based layer 418, those covered by a sealant layer 419, can be susceptible to moisture through adjacent exposed portions of the bio-based layer 418. Additionally, in one embodiment the sealant layer 419 is sufficiently thin to allow moisture to seep into the non-exposed portions after the package is opened. In a preferred embodiment, the sealant layer comprises a thickness of less than 2 microns. In a most preferred embodiment, the sealant layer comprises a thickness of 1 micron or less. As the adjacent exposed portions of the bio-based layer 418 begin to compost, the non-exposed portions of the bio-based layer 418 will begin composting as well.

The sealant layer 419 can be applied via any methods known in the art. In one embodiment the sealant layer 419 is applied by standard gravure. The sealant layer 419 can be solvent based, aqueous, 100% solids, and/or radiation cured.

Often the bio-based material manufactures, such as PLA manufactures, can only subject bio-based layers such as PLA, for example, to two layer extrusion. In other words, the PLA layer usually comprises a single coating. In such an embodiment, if the bio-based layer is coated with a primer, then the bio-based layer cannot be co-extruded with a sealant layer. As an example, if the bio-based layer comprises 4032D and is extruded with a primer, then a sealant layer cannot be extruded with the bio-based layer. Accordingly, in such embodiments the sealant layer must be applied in a different manner. The aforementioned technique of pattern applying the sealant layer allows the sealant layer to be applied via an aqueous or solvent coating, for example. As discussed above, other application methods can also be used. Thus, even in instances where the PLA can only undergo two layer extrusion, a sealant layer can still be applied after the extrusion step.

Furthermore, in one embodiment the seal temperature on the vertical form, fill, and seal machines ranges from about 210 to about 220° F. with a dwell time of about 20 ms to about 500 ms. Temperatures greater than about 220° F. often burn through the sealant and product side layers resulting in a compromised seal. In one embodiment, the instant invention allows the use of a non-compostable sealant layer 419 which can create a suitable seal at temperatures greater than about 220° F. If a compostable sealant layer 419 is required, then only a small number of compostable sealant materials are available. Often these compostable sealant layers cannot create a proper seal due to the operating conditions of the sealing machines. Thus, the functionality of many non-compostable sealant layer materials is lacking. Because a non-compostable sealant layer 419 can be utilized, a wider selection of materials can be utilized as a sealant layer 419. Accordingly, materials can be selected which can form a suitable seal at temperatures above 220° F., for example. Thus, the invention provides for a non-compostable sealant layer 419 to be utilized while still providing for biodegradation or compostability of the bio-based layers in the film.

Several advantages result from utilizing a non-compostable sealant layer. First, as described above, a wider selection of materials are available compared to materials which must be compostable. Second, compostable material for sealing layers is more expensive than non-compostable materials. The instant invention allows less expensive, and often better functioning non-compostable materials to be utilized in the sealant layer without compromising the biodegradation or compostable properties of the bio-based film.

The multi-layer packaging film can be made in methods previously described herein. In one embodiment the steps comprise adhering an outer layer comprising a bio-based film to a product side layer, wherein the product side layer comprises barrier properties and a bio-based layer. Thereafter, pattern applying a sealant layer on the exposed portion of the product side layer, wherein the sealant layer comprises non-compostable material.

FIG. 6 depicts a magnified schematic cross-section of a multi-layer packaging film 400 comprising a water permeable sealant layer made according to another embodiment of the invention. As depicted, the sealant layer 419 is applied to the entire surface of the bio-based layer 418. Thus, seal sealant layer 419 is applied with 100% coverage. In other embodiments, however, the sealant layer 419 is applied with less than 100% coverage, as described above. As an example, the sealant layer 419 can be pattern applied to the sealing surfaces as previously discussed.

In the embodiment depicted the sealant layer 419 comprises a water permeable material. The term, water permeable material, as used in this disclosure, shall refer to a material that can be permeated or penetrated by moisture. The material can include material which is absorbent, microporous or macroporous. In one embodiment, “water permeable” refers to a material that has a WVTR between about 150 g˜μm/m²·day and about 600 g˜μm/m²·day at 90% RH and 38° C.

In one embodiment the sealant layer is water permeable at room and/or elevated temperatures. By having a water permeable sealant layer 419, the bio-based layer 418 is susceptible to moisture exposure upon opening of the package. Thus, when the opened package is discarded, as an example, moisture can permeate or penetrate through the sealant layer and the bio-based layer 418 can begin degrading.

Examples of suitable permeable materials include but are not limited to EVOH, PVOH, EVA, polyvinyl acetate (“PVA”), polysulfone, polyether sulfone, cellulose, cellulose acetate, cellulose acetate butylrate, or cellulose triacetate. In one embodiment, the sealant layer comprises at least one of these materials. The sealant layer 419 can comprise virtually any water permeable material which can act as a sealing layer. In one embodiment the sealant layer 419 has a lower melting point than the materials that make up the rest of the film.

In one embodiment the sealant layer comprises polyethylene. In one embodiment the sealant layer comprises between about 10 to about 50% “OH” or alcohol containing groups. The alcohol groups add water solubility. Thus, for example, while pure polyethylene is water insoluble, adding alcohol groups increases the water solubility of the polyethylene compound. The alcohol groups increase the water solubility making the material water permeable.

The permeable sealant layer can be applied in any method discussed herein including applying an aqueous or solvent coating. Thus, as stated above, in instances where the bio-based layer 418 can only undergo two layer extrusion, a sealant layer can still be implemented after the extrusion step.

The multi-layer packaging film can be made in methods previously described herein. In one embodiment the steps comprise adhering an outer layer comprising a bio-based film to a product side layer, wherein the product side layer comprises barrier properties and a bio-based layer. Thereafter, applying a sealant layer to the exposed side of the product side layer, wherein the sealant layer comprises water permeable material.

Utilizing a water permeable sealant layer is contrary to the teachings of the art as the prior art discloses the use of water impermeable sealant layers. Water impermeable sealant layers act as an additional barrier layer. As such, it was previously taught that it was desirable that the sealant layer be water impermeable. As discussed herein, however, in some embodiments wherein the bio-based layers are sandwiched between two water impermeable layers, the moisture is prevented from contacting the bio-based layers and biodegradation or composting is halted. A water permeable sealant layer allows moisture to contact the bio-based layers and provides for subsequent biodegradation. Thus, the benefits of having a bio-based layer, for example, the bio-degrading properties, can be more fully realized.

The present invention provides numerous advantages over traditional, petroleum-based prior art films. First, the present invention reduces consumption of fossil fuels because a bio-based plastic is being used for one or more layers of the film that previously required a petroleum-based/fossil-fuel based polypropylene polymer. Consequently the film of the present invention is made with a renewable resource.

Second, the present invention lowers the amount of carbon dioxide in the atmosphere because the origin of the bio-based film is plant-based. Although the bio-based film can degrade into water and carbon dioxide in a relatively short period of time under composting conditions, if the film is placed into a landfill the carbon dioxide is effectively sequestered away and stored because of the lack of light, oxygen, and moisture available to degrade to the film. Thus, the carbon dioxide that was pulled from the atmosphere by the plant from which the bio-based film was derived is effectively placed into storage.

Third, less litter is visible because a portion of the film making up the resultant package is biodegradable. Further, because the biodegradable portions of the film are susceptible to moisture exposure after opening of the package, biodegradation can take place.

Fourth, energy is conserved because it takes less energy to create a film in accordance with the present invention than prior art petroleum based flexible films. For example 1 kg of PLA requires only 56 megajoules of energy, which is 20% to 50% fewer fossil resources than required to make petroleum-based plastics such as polypropylene.

Fifth, the invention provides more stable and less volatile pricing. Unlike petroleum-based commodities which fluctuate widely based upon the price of oil, bio-based commodities are more stable and less volatile. Further, bio-based films have the potential to benefit from continual improvements in genetically-engineered plants that can increase the desired feedstock composition and yield.

As used herein, the term “package” should be understood to include any container including, but not limited to, any food container made up of multi-layer thin films. The sealant layers, adhesive layers, print webs, and barrier webs as discussed herein are particularly suitable for forming packages for snack foods such as potato chips, corn chips, tortilla chips and the like. However, while the layers and films discussed herein are contemplated for use in processes for the packaging of snack foods, such as the filling and sealing of bags of snack foods, the layers and films can also be put to use in processes for the packaging of other low moisture products. While the invention has been particularly shown and described with reference to a preferred embodiment, it will be understood by those skilled in the art that various changes in form and detail may be made therein without departing from the spirit and scope of the invention.

What is claimed is:

1. A multi-layer packaging film comprising:
an outer layer comprising a first bio-based film;
a product side layer comprising a second bio-based film with barrier properties;
an adhesive layer adjacent to said outer layer and between said outer layer and said product side layer; and
a sealant layer located on a side of said product side layer opposite said adhesive layer, wherein said sealant layer covers less than 50% of said product side layer, wherein said sealant layer comprises non-compostable material, and wherein said multi-layer packaging film is a flexible film.

2. The film of claim 1 wherein said first or said second bio-based film comprises polyhydroxy-alkanoate.

3. The film of claim 1 wherein said first or said second bio-based film comprises polylactic acid.

4. The film of claim 1 wherein said product side layer comprises a barrier layer, an adhesion layer, and a bio-based layer.

5. The film of claim 1 wherein said first bio-based film further comprises a graphic image.

6. The film of claim 1 wherein said film is biodegradable.

7. The film of claim 1 wherein said sealant layer is water impermeable.

8. The film of claim 1 wherein said sealant layer comprises a first melting temperature, and wherein said second bio-based film comprises a second melting temperature, and wherein the first melting temperature is lower than the second melting temperature.

9. The film of claim 1 wherein said second bio-based film is metallized.

10. The film of claim 1 wherein said product side layer comprises a sealing surface, and wherein sealant layer is located on said sealing surface.

11. The film of claim 10 wherein said sealant layer is located only on said sealing surface.

12. The film of claim 1 wherein said sealant layer comprises an aqueous coating.

13. The film of claim 1 wherein said sealant layer comprises a solvent coating.

14. The film of claim 1 wherein said sealant layer comprises gaps.

15. The film of claim 1 wherein said sealant layer is activated by heat.

16. A multi-layer packaging film comprising:
an outer layer comprising a first bio-based film;
a product side layer comprising a second bio-based film with barrier properties;
an adhesive layer adjacent to said outer layer and between said outer layer and said product side layer; and
a sealant layer located on a side of said product side layer opposite said adhesive layer, wherein said sealant is water permeable, and wherein said multi-layer packaging film is a flexible film.

17. The film of claim 16 wherein said first or second bio-based film comprises polyhydroxy-alkanoate.

18. The film of claim 16 wherein said sealant layer comprises a first melting temperature, and wherein said second bio-based film comprises a second melting temperature, and wherein the first melting temperature is lower than the second melting temperature.

19. The film of claim 16 wherein said sealant layer comprises EVOH or PVOH.

20. The film of claim 16 wherein said sealant layer comprises at least one of EVOH, PVOH, EVA, PVA, polysulfone, polyether sulfone, cellulose, cellulose acetate, cellulose acetate butylrate, or cellulose triacetate.

21. The film of claim 16 wherein said sealant layer comprises an aqueous coating.

22. The film of claim 16 wherein said sealant layer comprises a solvent coating.

23. The film of claim 16 wherein said sealant layer is non-compostable.

24. The film of claim 16 wherein said sealant layer is activated by heat.

25. The film of claim 16 wherein said product side layer comprises a metallized film.

26. The film of claim 16 wherein said product side layer comprises a barrier layer, an adhesion layer, and a bio-based layer.

27. A method for making a multi-layer packaging film comprising the steps of:
a) adhering an outer layer comprising a bio-based film to a product side layer, wherein said product side layer comprises barrier properties, and wherein said product side layer comprises a bio-based layer;
b) pattern applying a sealant layer to said product side layer, wherein said sealant layer comprises non-compostable material.

28. The method of claim 27 wherein said sealant layer is water impermeable.

29. The method of claim 27 wherein said pattern applying comprises applying only along a sealing surface of said product side layer.

30. The method of claim 27 wherein said pattern applying comprises applying via coating.

31. The method of claim 27 wherein said adhering of step a) occurs via extrusion, and wherein said pattern applying occurs after step a).

32. A method for making a multi-layer packaging film comprising the steps of:
a) adhering an outer layer comprising a bio-based film to a product side layer, wherein said product side layer comprises barrier properties, and wherein said product side layer comprises a bio-based layer;
b) applying a sealant layer to said product side layer, wherein said sealant layer comprises a water permeable material.

33. The method of claim 32 wherein said applying comprises applying via coating.

34. The method of claim 32 wherein said adhering of step a) occurs via extrusion, and wherein said pattern applying occurs after step a).

35. The method of claim 32 wherein said sealant layer comprises EVOH or PVOH.

36. The method of claim 32 wherein said sealant layer comprises at least one of EVOH, PVOH, EVA, PVA, polysulfone, polyether sulfone, cellulose, cellulose acetate, cellulose acetate butylrate, or cellulose triacetate.
